(19) United States
(12) Patent Application Publication
(10) Pub. No.: US 2024/0353030 A1
(43) Pub. Date: Oct. 24, 2024

(54) Axial Slide Clip

(71) Applicant: Illinois Tool Works Inc., Glenview, IL (US)

(72) Inventor: Joel R. Lee, Peotone, IL (US)

(21) Appl. No.: 18/602,935

(22) Filed: Mar. 12, 2024

Related U.S. Application Data
(60) Provisional application No. 63/461,348, filed on Apr. 24, 2023.

(51) Int. Cl. F16L 3/10; F16L 3/223

(52) U.S. Cl. CPC F16L 3/1075; F16L 3/1008; F16L 3/223

(57) ABSTRACT

Described is a routing clip for routing tubes. The routing clip includes a first component and a second component pivotally coupled with the first component via a hinge to alternate between an open position and a closed position. When in the closed position, the first component and the second component define a plurality of pockets. Each of the plurality of pockets to secure one of the plurality of tubes and having a flexible band support element to conform to the one of the plurality of tubes. The flexible band support element includes a curved portion configured to conform to a shape of the one of the plurality of tubes. The curved portion is connected at each of its ends to a sidewall to bridge at least a portion of one of the plurality of pockets. The curved portion is connected at each of its ends to the sidewall via a wall feature and a bend feature.

### RELATED APPLICATION

The present application claims priority to U.S. Provisional Patent Application No. 63/461,348, filed Apr. 24, 2023, and entitled “Axial Slide Clip” which is hereby incorporated by reference in its entirety.

### BACKGROUND

Vehicular components, particularly those in automotive applications, often require routing, attachment, and fastening techniques that are both easy to manufacture and assemble. In many cases, it is essential to securely route or fasten objects, such as tubes, within or to the vehicle to prevent movement or shifting during operation, thereby avoiding potential damage, kinking, or rattling. For instance, tubes, hoses, wires, and other conduits are frequently affixed to vehicle components using routing clips.

Routing clips, along with their associated fastening techniques, must prioritize reliability and efficiency above all else. In certain instances, these clips are affixed to the vehicle either through panel openings or studs. Existing routing clips suffer from shortcomings such as the need for two materials to manage tube slide force and mitigate noise, vibration, and harshness (NVH) issues. Despite advancements in technology, there is still a need for routing clip assemblies with enhanced assembly characteristics to, inter alia, minimize the risk of slippage.

### SUMMARY

A routing clip can be used to couple objects relative to one another and/or to a component, such as automotive components. The present disclosure relates generally to a routing clip with improved characteristics, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a perspective view of the tube-retaining system in an open position (e.g., a loading position) in accordance with an aspect of this disclosure.

FIG. 1b illustrates a side elevation view of the tube-retaining system in a closed position (e.g., a loaded position).

FIG. 2a illustrates a perspective view of the routing clip in the closed position.

FIG. 2b illustrates a perspective view of the routing clip in the open position.

FIG. 2c illustrates a side elevation view of the routing clip in a closed position.

FIG. 2d illustrates a side elevation view of the routing clip in an open position.

FIGS. 2e through 2h illustrate, respectively, bottom plan, underside angle, top plan and topside angle views of the routing clip in an open position.

FIG. 2i illustrates a rear perspective view of the routing clip in a closed position.

FIG. 2j illustrates a perspective cross-sectional view of the routing clip in a closed position taken along cut-line A-A (FIG. 2a).

FIGS. 3a and 3b illustrate isometric views of an example tube-retaining system configured to secure one or more tubes relative to a component via the routing clip.

FIGS. 3c through 3h illustrate additional fastener styles suitable for coupling the carrier portion with the component in accordance with other aspects of this disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A routing clip can be used to couple objects relative to one another and/or to a component, such as automotive components. The disclosed routing clip (e.g., axial slide clip) can be used in a vehicle to route tubes, such as those used in HVAC, brake lines, conduit, or any tube-style medium for air, liquid, and/or electric conduit. In one example, the routing clip for securing a plurality of tubes relative to one another via a plurality of tube pockets. The routing clip can also include a fastener that is configured to engage the component via a stud or an opening.

Existing routing clips suffer from shortcomings, such as the need for two materials to manage tube slide force and mitigate noise, vibration, and harshness (NVH) issues. The disclosed routing clip presents several innovative features, including: 1) flexible rib features that securely encapsulate tubing; 2) precise axial and rotational control; 3) effective positional holding to stabilize and reduce NVH; and 4) tool-free assembly. Hence, the disclosed routing clip offers numerous benefits, including: 1) utilization of a single material (e.g., resin); 2) streamlined production processes; 3) enhanced quality standards; 4) reduction of work-in-progress (WIP) and associated costs; and 5) minimization or elimination of NVH.

In one example, a routing clip for routing a plurality of tubes comprises: a first component; and a second component pivotally coupled with the first component via a hinge and configured to alternate between an open position and a closed position, wherein, when in the closed position, the first component and the second component define a plurality of pockets, each of the plurality of pockets configured to secure one of the plurality of tubes, and wherein each of the plurality of pockets comprises a flexible band support element configured to conform to the one of the plurality of tubes.

In another example, a routing clip for routing a plurality of tubes comprises: a first component; a second component pivotally coupled with the first component via a hinge and configured to alternate between an open position and a closed position; and an exterior snap assembly configured to secure the routing clip in the closed position, wherein, when in the closed position, the first component and the second component define a plurality of pockets, each of the plurality of pockets configured to secure one of the plurality of tubes, and wherein each of the plurality of pockets comprises a flexible band support element configured to conform to the one of the plurality of tubes via a curved portion configured to conform to a shape of the one of the plurality of tubes.

In yet another examples, a routing clip for routing and securing a plurality of tubes to a component having an opening comprises: a first component; a second component pivotally coupled with the first component via a hinge and configured to alternate between an open position and a closed position; an exterior snap assembly configured to secure the routing clip in the closed position; and a fastener coupled to the second component and configured to couple to the component via the opening, wherein, when in the closed position, the first component and the second component define a plurality of pockets, each of the plurality of pockets configured to secure one of the plurality of tubes, and wherein each of the plurality of pockets comprises a flexible band support element configured to conform to the one of the plurality of tubes via a curved portion configured to conform to a shape of the one of the plurality of tubes.

In some examples, the flexible band support element comprises a curved portion configured to conform to a shape of the one of the plurality of tubes. The curved portion can be connected at each of its ends to a sidewall to bridge at least a portion of one of the plurality of pockets. The curved portion can be connected at each of its ends to the sidewall via a wall feature and a bend feature.

In some examples, the routing clip further comprises an exterior snap assembly configured to secure the routing clip in the closed position. The exterior snap assembly can comprise a first clip coupled to the first component that is configured to engage a corresponding second clip coupled to the second component.

In some examples, the routing clip further comprises one or more interior snap assemblies positioned between adjacent pockets. Each of the one or more interior snap assemblies can comprise a first clip coupled to the first component that is configured to engage a corresponding second clip coupled to the second component.

In some examples, the routing clip is fabricated as a unitary structure.

In some examples, the routing clip further comprises a fastener configured to couple the routing clip to a component. The fastener can be coupled to the second component.

In some examples, the hinge is a living hinge or comprises a shaft and a pivot socket.

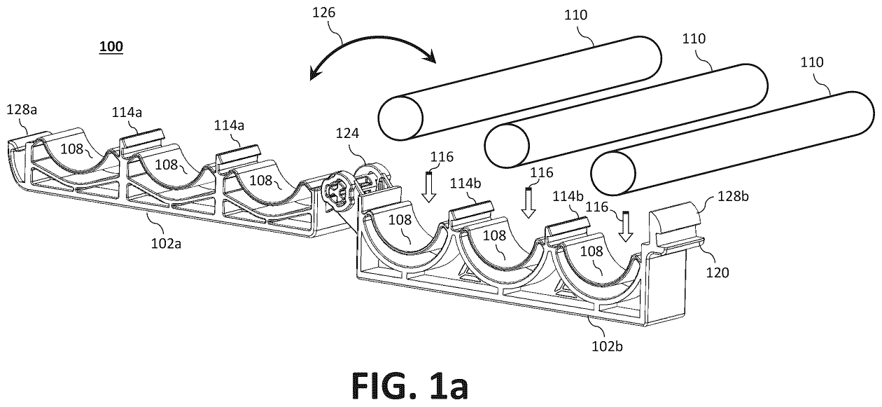

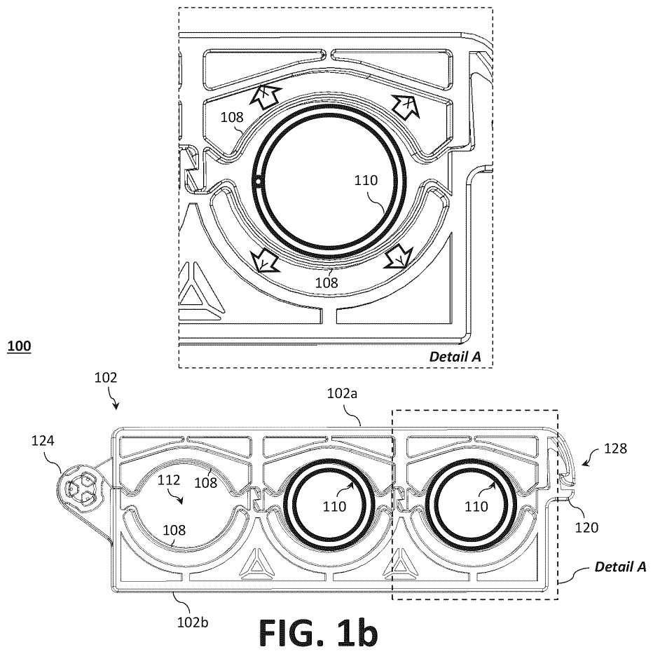

FIGS. 1a and 1b illustrate a tube-retaining system 100 in accordance with an aspect of this disclosure that is configured to route and secure a plurality of tubes 110 relative to one another via a routing clip 102. More specifically, FIG. 1a illustrates a perspective view of the tube-retaining system 100 in an open position (e.g., a loading position), while FIG. 1b illustrates a side elevation view of the tube-retaining system 100 in a closed position (e.g., a loaded position).

The routing clip 102 is configured to couple with and/or secure one or more objects (illustrated as tubes 110) relative to one another. For example, the routing clip 102 is illustrated with a plurality of pockets 112, each of which is configured to route and secure a tube 110. While the routing clip 102 will be described primarily as a routing clip configured to secure tubes 110, the routing clip 102 can be used to attach other objects and components.

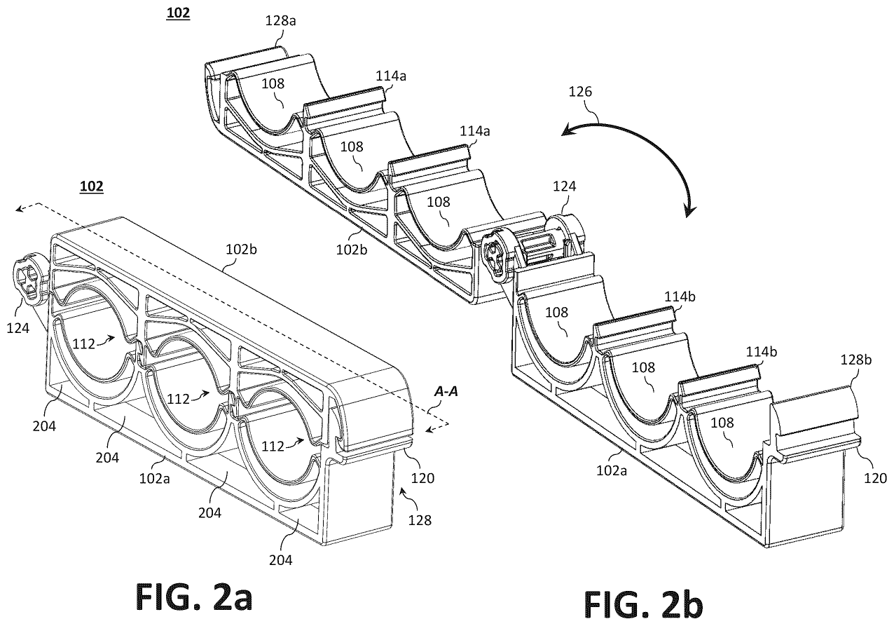

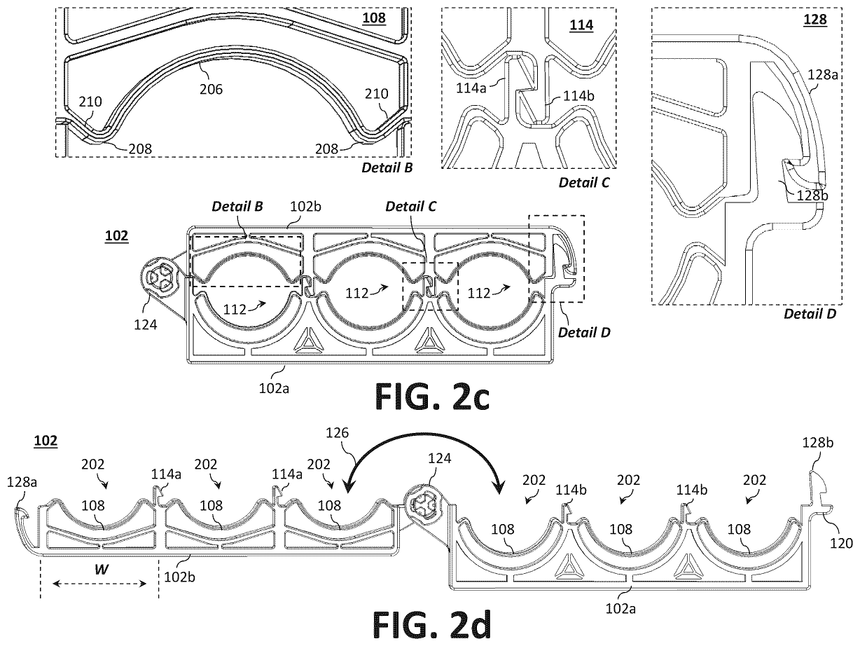

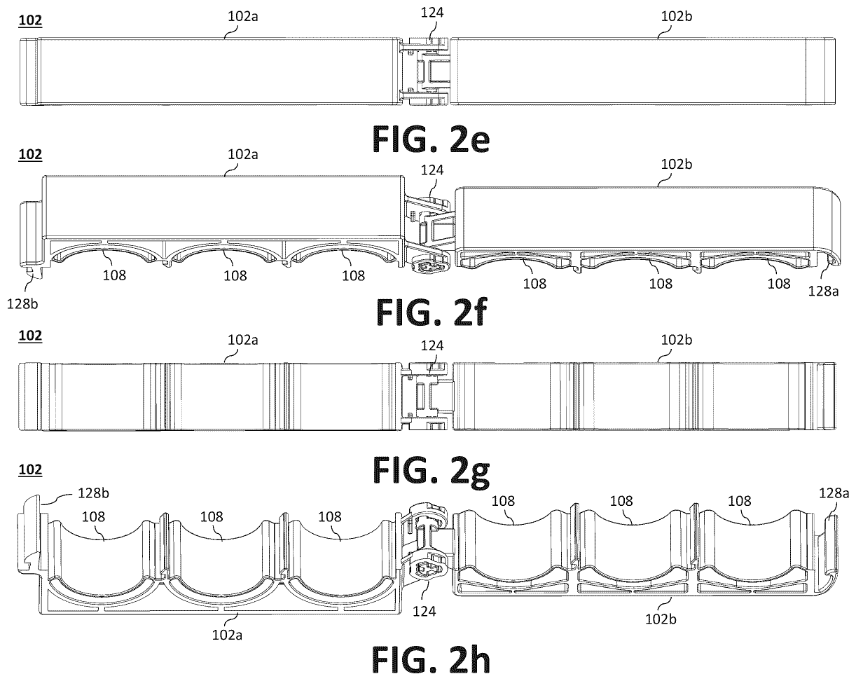

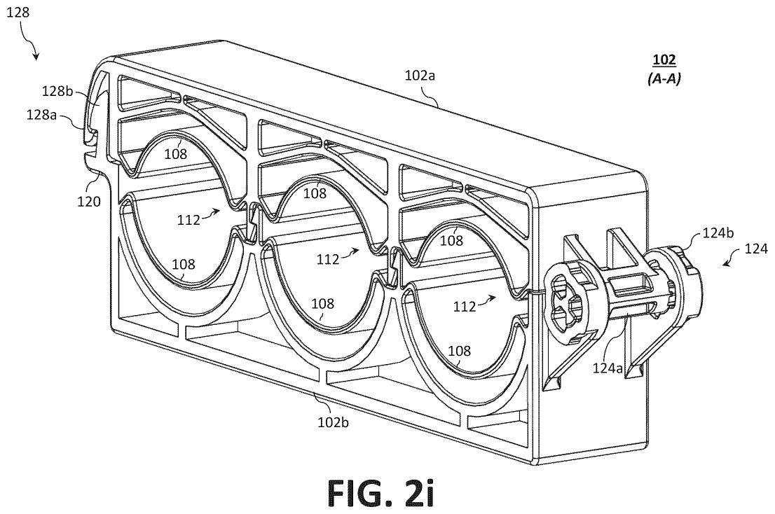

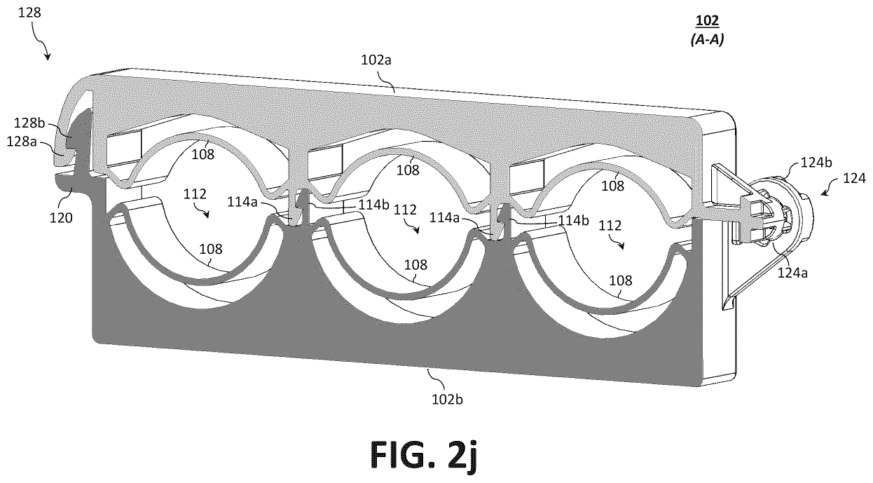

FIGS. 2a through 2j illustrate the routing clip 102 without the tubes 110 installed. More specifically, FIG. 2a illustrates a perspective view of the routing clip 102 in a closed position (e.g., a loaded position), while FIG. 2b illustrates a perspective view of the routing clip 102 in an open position (e.g., a loading position). FIG. 2c illustrates a side elevation view of the routing clip 102 in a closed position, while FIG. 2d illustrates a side elevation view of the routing clip 102 in an open position. FIGS. 2e through 2h illustrate, respectively, bottom plan, underside angle, top plan and topside angle views of the routing clip 102 in an open position. FIG. 2i illustrates a rear perspective view of the routing clip 102 in a closed position, while FIG. 2j illustrates a perspective cross-sectional view of the routing clip 102 in a closed position taken along cut-line A-A (FIG. 2a).

In the illustrated example, the routing clip 102 includes a first component 102a (e.g., an upper bridge component) and a second component 102b (e.g., a lower bridge component). As illustrated in FIG. 1a and 1b, the first component 102a can be pivoted about a hinge 124 between an open position (FIG. 1a) and the closed position (FIG. 1b) as indicated by arrow 126 to provide access to the plurality of pockets 112 during installation of the one or more tubes 110 (or other objects).

Each of the first component 102a and the second component 102b comprises or otherwise defines a plurality of recesses 20. When the routing clip 102 is in the closed position, a recess 202 of the first component 102a aligns with a complimentary recess 202 of the second component 102b to define a pocket 112 configured to secure a tube 110. When in the open position, a tube 110 can be inserted into each of the plurality of pockets 112 by urging the tube 110 toward the respective tube pocket 112 (or portion thereof, such as the recess 202) in the direction indicated by arrow 116. Once the one or more tubes 110 are inserted, the first component 102a can be pivoted about the hinge 124 to the closed position.

The hinge 124 may be a pivoting hinge having two interlocking components, such a shaft 124a and a pivot socket 124b (e.g., an opening). The shaft 124a fits in or through the pivot socket 124b to provide a stable axis of rotation, allowing them to pivot relative to each other. In another example, the hinge 124 can be a living hinge, which is a type of hinge made from a flexible material that allows for repeated bending or flexing without breaking or losing its integrity. Living hinges are typically constructed from elastomers or thermoplastic materials that have flexibility and resilience. In an example, the living hinge is a flash gate hinge that is integrally formed with the first component 102a and the second component 102b.

In some examples, the routing clip 102 comprises one or more windows 204 (e.g., recesses, cut outs, or openings) formed in or on the routing clip 102. The one or more windows 204 can serve to reduce the amount of material needed to fabricate the routing clip 102, thus reducing material cost and part weight.

In the illustrated example, an exterior snap assembly 128 is further provided at a free end of the routing clip 102 (e.g., opposite the hinge 124) to serve as a primary snap assembly. In the illustrated example, the first component 102a includes a first clip 128a that is configured to engage a corresponding second clip 128b of the second component 102b. The first clip 128a and the second clip 128b may be for example, a hook, ledge, edge, or other protrusion. In some examples, the exterior snap assembly 128 further includes or define a lip 120 is sized to provide a bearing area for positioning a finger during closure and/or release of the exterior snap assembly 128, thus improving ergonomics for the operator.

In addition to or in lieu of the exterior snap assembly 128, the routing clip 102 may include or define one or more interior snap assemblies 114 to serve as secondary snap assemblies to provide additional attachment points between the first component 102a and the second component 102b along its length. Distributing one or more interior snap assemblies 114 along the span between the hinge 124 and the exterior snap assembly 128 mitigates bowing and/or flexing of the first component 102a and/or the second component 102b, thus helping to maintain a secure attachment with the plurality of tubes 110. In the illustrated example, an interior snap assembly 114 is provided between adjacent pockets 112. Like the exterior snap assembly 128, each of the interior snap assemblies 114 includes a first clip 114a on the first component 102a that is configured to engage a corresponding second clip 114b of the second component 102b.

Each of the plurality of pockets 112 can be shaped as a cylindrical channel (when in a closed position, as illustrated in FIGS. 1b and 2a, for example) with an inner diameter that generally corresponds to an outer diameter of the tubes 110. The one or more tubes 110 may be, for example, ridged pipes (metal, plastic, rubber, etc.), brake lines, fuel lines, wires, cables (e.g., electric cables), pipes, and/or any other tubular structure that may be secured to a component 304. In some examples, the routing clip 102 is configured to retain tubes 110 of different diameters by, for example, adjusting the size of one or more of the plurality of pockets 112.

Each of the illustrated pockets 112 depicted in the figures is equipped with a plurality of flexible band support elements 108 strategically designed to interact with and/or provide support for tube 110 when the routing clip 102 is in its closed position. While each pocket 112 is depicted with two plurality of flexible band support elements 108, additional or fewer (e.g., 1) flexible band support elements 108 can be positioned in each pockets 112 depending on the design needs (e.g., the size and/or shape of the tubes 110 to be secured).

The tube clip 102 is designed to provide clamping force onto tubes 110 within a single resin molded solution. The tube clip 102 is designed to accept diametrical style tubes 110. To that end, flexible band support elements 108 are positioned within the illustrate tube clip 102 to accommodate oval-shaped and other non-circular tube diameters and varying tolerances in the roundness of mass-produced tubes/pipes. Once the tubes 110 have been inserted into pockets 112, the first component 102a is rotated about the hinge 124 and over the tubes 110 such that the first clip 128a engages the second clip 128b to assume a completed installed position that encapsulates the tubes 110. Upon full fastening, the flexible band support elements 108 engage the tubes 110 and flex in directions X and Y as illustrated in FIG. 1b (Detail A).

The flexibility of the flexible band support elements 108 enables the routing clip 102 to flex diametrically within the pockets 112, effectively accommodating the external shape or contour of tube 110, even under conditions of compression or deformation. As depicted, each flexible band support element 108 bridges or otherwise spans the width of its corresponding recess 202. In other words, as shown in FIGS. 2c and 2d, each flexible band support element 108 is affixed at both ends to a sidewall to bridge the recess 202.

In the illustrated example, each of the flexible band support elements 108 comprises a curved segment 206 configured to flex and/or conform to the contours of tube 110. This curved segment 206 is affixed at both ends to a sidewall (e.g., opposed sidewalls) of the recess 202 (e.g., within the confines of the pocket 112) via an integrated wall feature 210 and a bend feature 208. In this particular illustration, the bend feature 208 measures approximately 80-100 degrees, or approximately 90 degrees. The bend feature 208 and wall feature 210 cooperate to facilitate positional control, serving as integral components within the system function to regulate the integrated angle design during engagement with the tube 110.

While three pockets 112 are illustrated, additional or fewer pockets 112 may be provided depending on the design needs (e.g., the number of tubes 110 to be secured). The width of the routing clip 102 would be adjusted accordingly to accommodate the desired number of pockets 112 and/or tubes 110. Further, the routing clip 102 can employ pockets 112 of different diameters in each location.

The routing clip 102 may be formed as a unitary structure. In one example, the routing clip 102 can be fabricated via mold tooling and a plastic-injection molding process. In another example, the routing clip 102 can be a printed thermoplastic material component that can be printed with great accuracy and with numerous details, which is particularly advantageous, for example, in creating components requiring complex and/or precise features. In addition, additive manufacturing techniques obviate the need for mold tooling typically associated with plastic injection molding, thereby lowering up-front manufacturing costs, which is particularly advantageous in low-volume productions. In some examples, the routing clip 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, the routing clip 102 may be formed or otherwise fabricated at different resolutions during a printing operation. For example, the routing clip 102 (or portions thereof) may be printed at a lower resolution than that of the fastener 302 or vice versa as needed for a particular application.

While in some applications, it may be desirable to secure a plurality of tubes 110 relative to one another, but not necessary to secure them to the component 304 (such as those examples described and illustrated in FIGS. 1a through 1b and FIGS. 2a through 2j), in other examples the routing clip 102 can further be used to secure the tubes 110 relative to a component 304.

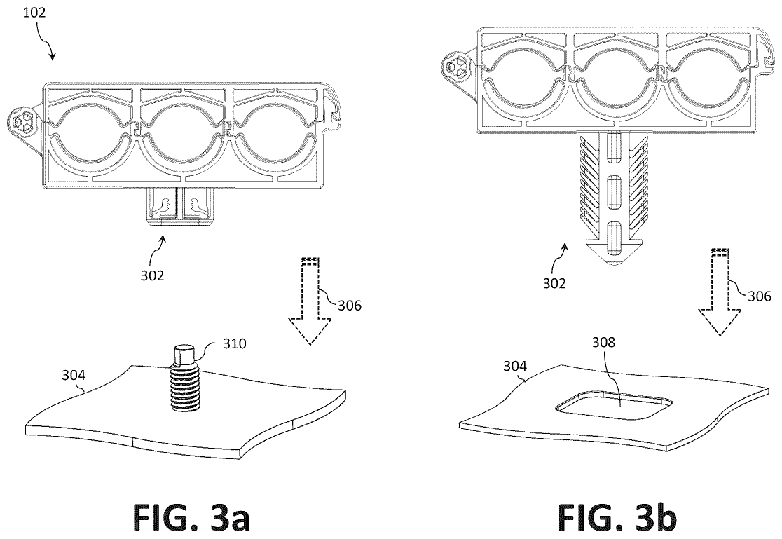

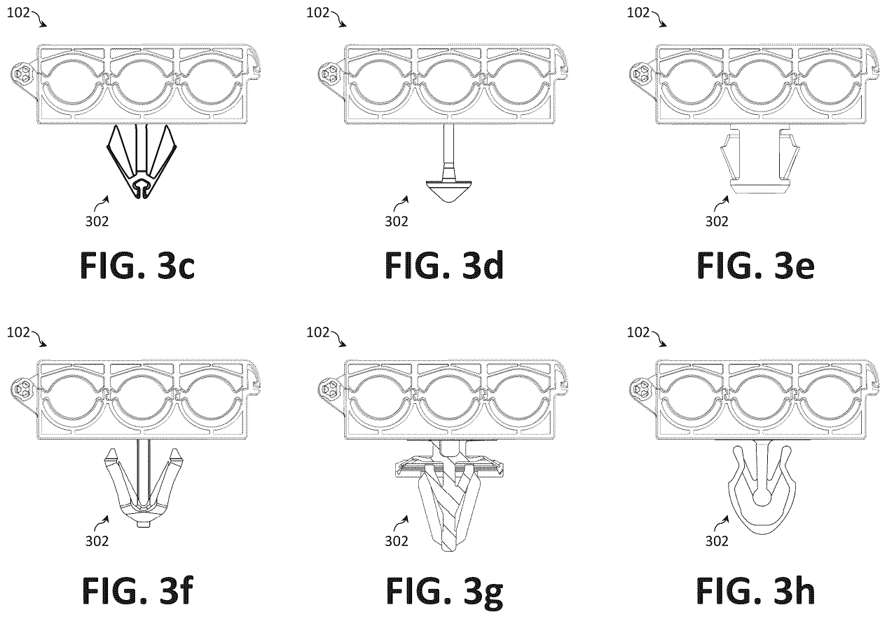

FIGS. 3a and 3b illustrate isometric views of an example tube-retaining system 100 configured to secure one or more tubes 110 relative to a component 304 via a routing clip 102. In these examples, the routing clip 102 includes a fastener 302 that serves to couple the routing clip 102 to the component 304. As illustrated, the fastener 302 is generally perpendicular to the routing clip 102 such that a central longitudinal axis runs down the center of the fastener 302.

The fastener 302 can be integrated with the routing clip 102 or attached during assembly (e.g., via adhesives, a welding process, a mechanical coupling, or the like). In some examples, the routing clip 102 and/or fastener 302 may include additional features, such as ribs and wings to mitigate noise and/or rattle between the routing clip 102 and the component 304. In other examples, depending on the material type, the fastener 302 can be omitted and routing clip 102 may be formed on or integrated with the component 304 during manufacturing of the component 304, whether via printing (e.g., an addition manufacturing process), molding, or layup. By integrating the routing clip 102 with the component 304, the routing clip 102 eliminates setup variation, reduces the number of parts (and part numbers), etc.

FIG. 3a illustrates a fastener 302 configured as a post-retainer assembly, while FIG. 3b illustrates the fastener 302 configured as a push-pin assembly (sometimes called trees, pine trees, Christmas trees, etc.). The component 304 may be, for example, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the component 304 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. The component 304 may include, define, or otherwise provide a stud 310 and/or an opening 308 (e.g., a hole), either of which may be formed during or after manufacturing of the component 304. To form the connection with the component 304, the fastener 302 can, for example, slide onto the stud 310 (FIG. 3a) or into the opening 308 (FIG. 3b) formed in or on a surface of the component 304 as indicated by the arrow 306.

With reference to FIG. 3a, the fastener 302 configured as a post-retainer assembly comprises a plurality of stud-retention features that extend inwardly toward a central longitudinal axis to grip a stud 310. In the illustrated example, the stud 310 is threaded (or ribbed) to increase fastening strength once assembled by increasing the friction between the stud 310 and the stud-retention features.

With reference to FIG. 3b, the illustrated push-pin assembly includes a plurality of fins arranged along a length of the body sidewall that are resiliently connected to the body sidewall and configured to deflect as the fastener 302 is passed through an opening 308 formed in the component 304. The fins may be shaped as blades, teeth, barbs, or the like. As illustrated, the fins are angled away from the central longitudinal axis and are configured to deflect inward toward the central longitudinal axis as the fastener 302 is passed through the opening 308 in the component 304. The fins are angled upwardly relative to the central longitudinal axis (forming an acute angle between each fin and the central longitudinal axis) to resist pullout forces.

While FIGS. 3a and 3b illustrate a fastener 302 configured as, respectively, a post-retainer assembly and as a push-pin assembly, other fastener designs are contemplated. FIGS. 3c through 3h illustrate additional fastener styles suitable for coupling the carrier portion with the component in accordance with other aspects of this disclosure. For example, FIGS. 3c through 3h illustrate additional fastener styles that can be used as the fastener 302 suitable for coupling the routing clip 102 with the component 304. Specifically, FIGS. 3c through 3h illustrate, respectively, a W-shaped clip fastener (illustrated as a 2-legged clip fastener), pin fastener, a box-prong fastener (illustrated as a 2-legged box-prong fastener), a specialty clip assembly (e.g., a CenterLok™ fastener, which is available from Deltar®), a clip assembly with four retaining legs, and an clip assembly with two snap-engaging seats. The clip assembly with four retaining legs, which is illustrated in FIG. 3g as a partial cross sectional view, is further described in connection with commonly-owned U.S. Pat. No. 10,385,901 to Jeffrey J. Steltz. The clip assembly with two snap-engaging seats of FIG. 3h is further described in connection with commonly-owned U.S. Pat. No. 10,018,214 to Fulvio Pacifico Yon.

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A routing clip for routing a plurality of tubes, the routing clip comprising:
a first component; and
a second component pivotally coupled with the first component via a hinge and configured to alternate between an open position and a closed position,
wherein, when in the closed position, the first component and the second component define a plurality of pockets, each of the plurality of pockets configured to secure one of the plurality of tubes, and
wherein each of the plurality of pockets comprises a flexible band support element configured to conform to the one of the plurality of tubes.

2. The routing clip of claim 1, wherein the flexible band support element comprises a curved portion configured to conform to a shape of the one of the plurality of tubes.

3. The routing clip of claim 2, wherein the curved portion is connected at each of its ends to a sidewall to bridge at least a portion of one of the plurality of pockets.

4. The routing clip of claim 3, wherein the curved portion is connected at each of its ends to the sidewall via a wall feature and a bend feature.

5. The routing clip of claim 1, further comprising an exterior snap assembly configured to secure the routing clip in the closed position.

6. The routing clip of claim 5, wherein the exterior snap assembly comprises a first clip coupled to the first component that is configured to engage a corresponding second clip coupled to the second component.

7. The routing clip of claim 1, further comprising one or more interior snap assemblies positioned between adjacent pockets.

8. The routing clip of claim 7, wherein each of the one or more interior snap assemblies comprises a first clip coupled to the first component that is configured to engage a corresponding second clip coupled to the second component.

9. The routing clip of claim 1, wherein the routing clip is fabricated as a unitary structure.

10. The routing clip of claim 1, further comprising a fastener configured to couple the routing clip to a component.

11. The routing clip of claim 10, wherein the fastener is coupled to the second component.

12. The routing clip of claim 1, wherein the hinge is a living hinge.

13. The routing clip of claim 1, wherein the hinge comprises a shaft and a pivot socket.

14. A routing clip for routing a plurality of tubes, the routing clip comprising:
a first component;
a second component pivotally coupled with the first component via a hinge and configured to alternate between an open position and a closed position; and
an exterior snap assembly configured to secure the routing clip in the closed position,
wherein, when in the closed position, the first component and the second component define a plurality of pockets, each of the plurality of pockets configured to secure one of the plurality of tubes, and
wherein each of the plurality of pockets comprises a flexible band support element configured to conform to the one of the plurality of tubes via a curved portion configured to conform to a shape of the one of the plurality of tubes.

15. The routing clip of claim 14, wherein the curved portion is connected at each of its ends to a sidewall to bridge at least a portion of one of the plurality of pockets.

16. The routing clip of claim 15, wherein the curved portion is connected at each of its ends to the sidewall via a wall feature and a bend feature.

17. The routing clip of claim 1, further comprising one or more interior snap assemblies positioned between adjacent pockets, wherein each of the one or more interior snap assemblies comprises a first clip coupled to the first component that is configured to engage a corresponding second clip coupled to the second component.

18. A routing clip for routing and securing a plurality of tubes to a component having an opening, the routing clip comprising:
a first component;
a second component pivotally coupled with the first component via a hinge and configured to alternate between an open position and a closed position;
an exterior snap assembly configured to secure the routing clip in the closed position; and
a fastener coupled to the second component and configured to couple to the component via the opening,
wherein, when in the closed position, the first component and the second component define a plurality of pockets, each of the plurality of pockets configured to secure one of the plurality of tubes, and
wherein each of the plurality of pockets comprises a flexible band support element configured to conform to the one of the plurality of tubes via a curved portion configured to conform to a shape of the one of the plurality of tubes.

19. The routing clip of claim 18, wherein the curved portion is connected at each of its ends to a sidewall to bridge at least a portion of one of the plurality of pockets.

20. The routing clip of claim 19, wherein the curved portion is connected at each of its ends to the sidewall via a wall feature and a bend feature.
